(19) United States
(12) Patent Application Publication
(10) Pub. No.: US 2010/0009102 A1
(43) Pub. Date: Jan. 14, 2010

(54) METHOD OF AND APPARATUS FOR MANUFACTURING A LARGE SURFACE PANEL, A LARGE SURFACE PANEL, AND A SET OF INDIVIDUAL PANELS

(75) Inventor: Bruno Paul Louis Vermeulen, Aldeneik-masseik (BE)

Correspondence Address: WESTMAN CHAMPLIN & KELLY, P.A., SUITE 1400, 900 SECOND AVENUE SOUTH, MINNEAPOLIS, MN, 55402, US

(73) Assignee: Spanolux N.V. -Div. Balterio, Sint-Baafs-Vijve (BE)

(21) Appl. No.: 12/444,218

(22) PCT Filed: Oct. 3, 2007
(86) PCT No.: PCT/EP07/60503

§ 371 Date: Jun. 22, 2009

(51) Int. Cl. B32B 1/06; B05D 1/36; B32B 3/10; B05C 11/02

(52) U.S. Cl. 428/34.1; 427/265; 428/201; 118/102

(57) ABSTRACT

The invention provides a method of manufacturing a large surface panel, which has a decoration layer with a repetitive decoration layer pattern, and a repetitive surface structure pattern, wherein the frequencies of the repetitive patterns of the surface structure and the decoration layer are different. The invention also provides a set of individual panels. The individual panels are cut out from the large surface panel and can be collected and wrapped into a package. The package comprises at least a plurality of individual panels having identical decoration layer patterns, but different surface structure patterns. The invention provides large surface panels and individual panels which present a very good imitation of panels made of a natural material.

### CROSS-REFERENCE TO RELATED APPLICATION

This application is a National Stage Filing of International Application PCT/EP2007/060503, filed Oct. 3, 2007 and published as WO 2008/040760 in English.

### BACKGROUND

The discussion below is merely provided for general background information and is not intended to be used as an aid in determining the scope of the claimed subject matter.

Aspects of the invention relates to a method of manufacturing a large surface panel, including the steps of providing a large surface panel having at least one side to be decorated, applying a decoration layer on the side in a repetitive decoration layer pattern in at least a machining direction along the large surface panel, and applying a repetitive surface structure pattern on the side in at least the same machining direction.

Such a method is well-known, for example for manufacturing a large surface laminate panel which is cut into a plurality of individual panels in a next manufacturing step. The individual panels are known in various embodiments, for example in the form of laminate floor panels. The repetitive patterns on the side of a large surface panel are generally applied to achieve an efficient manufacturing process. Such panels are made on a wood basis and have a decoration layer to imitate natural materials such as wood or other natural materials. Furthermore, they have a surface structure pattern to improve the natural appearance further.

### SUMMARY

This Summary and Abstract are provided to introduce some concepts in a simplified form that are further described below in the Detailed Description. This Summary and Abstract are not intended to identify key features or essential features of the claimed subject matter, nor are they intended to be used as an aid in determining the scope of the claimed subject matter. In addition, the description herein provided and the claimed subject matter should not be interpreted as being directed to addressing any of the short-comings discussed in the Background.

An aspect of this invention herein described has the decoration layer and the repetitive surface structure applied such that the frequencies of the repetitive patterns of the surface structure and the decoration layer are different.

Due to this feature of the invention a large surface panel can be manufactured which has at least a decorated side having a repetitive decoration layer pattern with a frequency which differs from that of its surface structure pattern. The variation of surface structure pattern in addition to a variation of decoration layer surface structure pattern increases the number of apparently different individual panels which improves the natural appearance of an assembly of the individual panels, such as a floor covering.

The frequency of the surface structure pattern can be lower than that of the decoration layer pattern. Particularly, this is advantageous in the case when the large surface panel is cut into a plurality of individual panels which have the same length as one cycle of the repetitive decoration layer pattern, as it provides the opportunity to manufacture an adjacent individual panel having the same length and same decoration layer pattern, but with an entirely different surface structure pattern. Furthermore, the ratio between the frequencies may be a whole number. In this case, since the frequencies of the repetitive patterns of the surface structure and the decoration layer are different, and the ratio between the frequencies is a whole number, the whole number is more than unity, or equal or larger than two. This still means that the frequency of the surface structure pattern may be higher or lower than the frequency of the decoration layer pattern.

The surface structure pattern may be applied after applying the decoration layer. It is, for example, possible to apply a protective layer onto the decoration layer and then apply a surface treatment to the protective layer. The surface treatment may comprise a step of embossing the protective layer. These steps are relatively simply to implement in the manufacturing method such as in the prior art.

Preferably, an embossing roller is applied for embossing the side, since this provides the possibility of a continuous manufacturing method.

The embossing roller may have a circumferential surface which is treated by chemical embossing or mechanical embossing to obtain at least an embossed region on the surface. This is a relatively simple method to achieve any embossed region.

The surface structure pattern preferably has a realistic texture, imitating natural materials. Therefore, the surface structure pattern can be derived from a natural material by preparing an outer surface of a piece of the material by etching, scanning an image thereof, loading the image in a control programme of a surface structuring machine, and the surface structure pattern is applied by the machine.

The large surface panel may be cut into individual panels in at least the machining direction. Preferably, the individual panels are cut out at such lengths that each adjacent individual panel has an identical decoration layer pattern. This is beneficial for obtaining an efficient repetitive character of the manufacturing process. It is, however, also possible to vary the lengths of the individual panels.

Aspects of the invention also relate to a large surface panel comprising at least an upper surface which is provided with a decoration layer having a repetitive decoration layer pattern in at least one direction along the surface, and a repetitive surface structure pattern in at least the same direction, wherein the frequencies of the repetitive patterns of the surface structure and the decoration layer are different.

Aspects of the invention also relate to a set of individual panels, wherein each thereof has at least a side provided with a decoration layer having a decoration layer pattern, and a surface structure pattern, wherein the set at least comprises two individual panels including identical decoration layer patterns, but different surface structure patterns. The set can be wrapped into at least a package. This means that the package comprises individual panels which have identical decoration layer patterns, but different surface structure patterns. For example, if the individual panels are applied for making a floor covering, the covering will provide a great natural appearance due to the large extent of variations in decoration layer patterns and surface structure patterns.

Aspects of the invention also relate to an apparatus for manufacturing a large surface panel such as described hereinbefore.

An alternative method of manufacturing a large surface panel according to an aspect of the invention includes the steps of providing a large surface panel having at least one side to be decorated, applying a decoration layer on the side in a repetitive decoration layer pattern in at least a machining direction along the large surface panel, applying at least one of a repetitive surface structure pattern on the side and a second substantially transparent decoration layer bearing a second repetitive decoration layer pattern in at least the same machining direction. The method is characterized in that the decoration layer and at least one of the repetitive surface structure and the second decoration layer are applied such that the frequencies of the repetitive patterns of the surface structure and at least one of the decoration layers, or of the repetitive patterns of the decoration layers, are different. The advantage of this method is that a large surface panel providing a lot of variations in appearance can be obtained, such that the natural appearance thereof is still further improved. The parameters to be varied are the surface structure pattern, the decoration layer pattern and the second decoration layer pattern. The second substantially transparent decoration layer may be made of such a material that it becomes more transparent when it is pressed onto the decoration layer.

The second decoration layer may be a protective layer applied onto the decoration layer, and the repetitive surface structure pattern may be obtained by applying a surface treatment of the protective layer to adapt the texture and/or the gloss of the surface structure. This means that the surface structure pattern and the second decoration layer pattern are integrated in the protective layer.

It is noted that in case of pressing the second decoration layer on the decoration layer the surface structure pattern may be pressed both in the second decoration layer and the underlying material, such as the decoration layer and a core of the large surface panel. The surface structure is not necessarily limited to the second decoration layer only.

An alternative embodiment of the large surface panel according to an aspect of the invention may comprise at least an upper surface provided with a decoration layer having a repetitive decoration layer pattern in at least one direction along the surface, and at least a second pattern superposed on the decoration layer pattern in at least the same direction, wherein the frequencies of the repetitive patterns are different. The second pattern may be a surface structure pattern and a third pattern may be a second decoration layer pattern. Due to the different frequencies a great number of variations in appearance of the large surface panel is obtained.

Aspects of the invention also relate to a panel which comprises on at least a side a laminate including a decoration layer having a decoration layer pattern, and an overlay on which there is printed an overlay pattern which is superposed on the decoration layer pattern to form a combined pattern.

### BRIEF DESCRIPTION OF THE DRAWINGS

The invention will hereafter be elucidated with reference to the very schematic accompanying drawings.

FIG. 1 is a very schematic plan view of a large surface panel such as known in the art.

FIG. 2 is similar to FIG. 1, illustrating a large surface panel, which is partly provided with a surface structure pattern.

FIG. 3 is a very schematic perspective view of an embossing roller.

FIG. 4 is a view similar to FIG. 2, but illustrating an alternative embodiment of the large surface panel, which is provided with a second decoration layer partly bearing a second decoration layer pattern.

### DETAILED DESCRIPTION OF THE ILLUSTRATIVE EMBODIMENTS

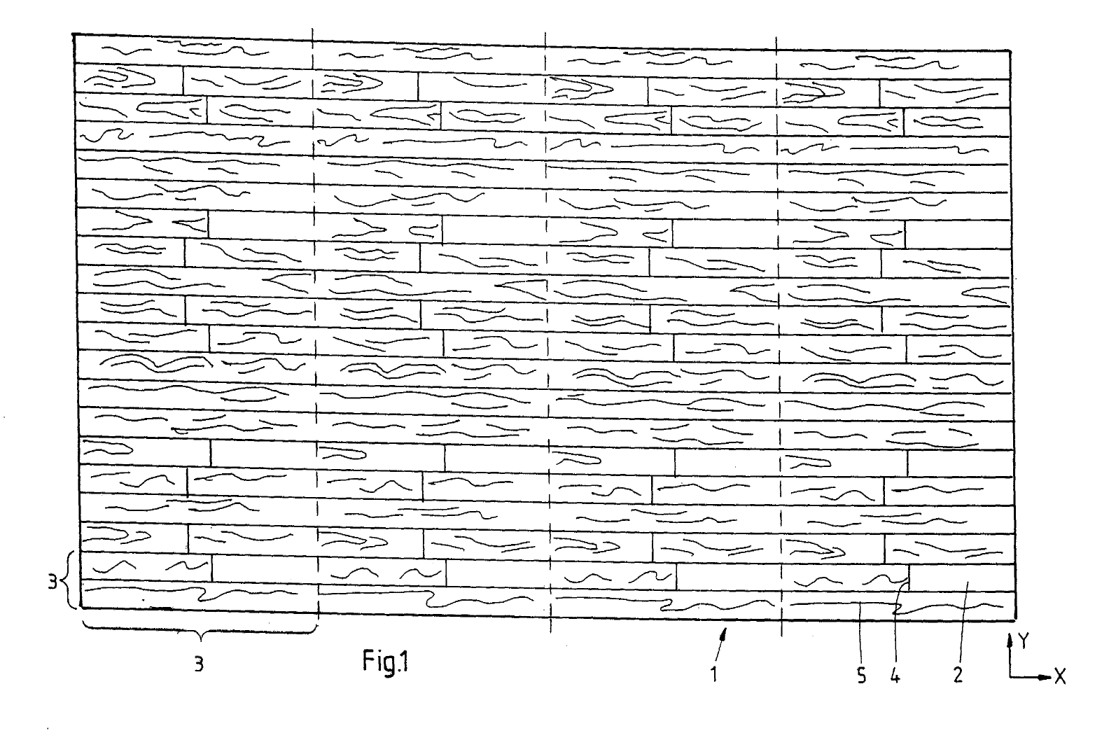

FIG. 1 illustrates an embodiment of a rectangular large surface panel 1 which is manufactured according to a method known in the art. It has at least one side, which is in this case an upper surface 2 which is provided with a decoration layer which imitates a natural material, such as wood. This decoration layer may include a laminate of paper layers impregnated with resin and a protective top layer. The core of the large surface panel 1 may comprise one or more layers of MDF, HDF, HTSP, PVC, composites or the like, and possibly a balancing layer may be provided on the lower surface of the large surface panel 1.

In a next manufacturing step the large surface panel 1 may be cut into rectangular individual panels 3 which are machined further, for example for providing each thereof with couplers (not shown) to be able to couple the individual panels 3 to each other in order to make a floor covering.

The large surface panel 1 shown in FIG. 1 comprises four individual panels 3 in X direction and ten individual panels 3 in Y direction. The borders between the individual panels 3 in X direction are indicated by dashed lines. The large surface panel has a repetitive decoration layer pattern 4 and a repetitive surface structure pattern 5 in a machining direction which is defined as the X direction. The decoration layer pattern is represented by straight lines in FIG. 1. The decoration layer pattern 4 imitates two or more parallel planks of wood within each individual panel 3. Of course, many variations in pattern shape are conceivable. The surface structure pattern 5 varies in terms of its texture within each of the rectangular individual panels 3 which is represented by curved lines in FIG. 1. The texture may have a (three dimensional) shape and size such as that of real planks of wood, such that the texture follows the pattern in the decoration layer (embossing in register).

In the large surface panel 1 of FIG. 1 four out of forty panels are identical, because of the repetitive character of both the decoration layer pattern 4 and the surface structure pattern 5 in X direction.

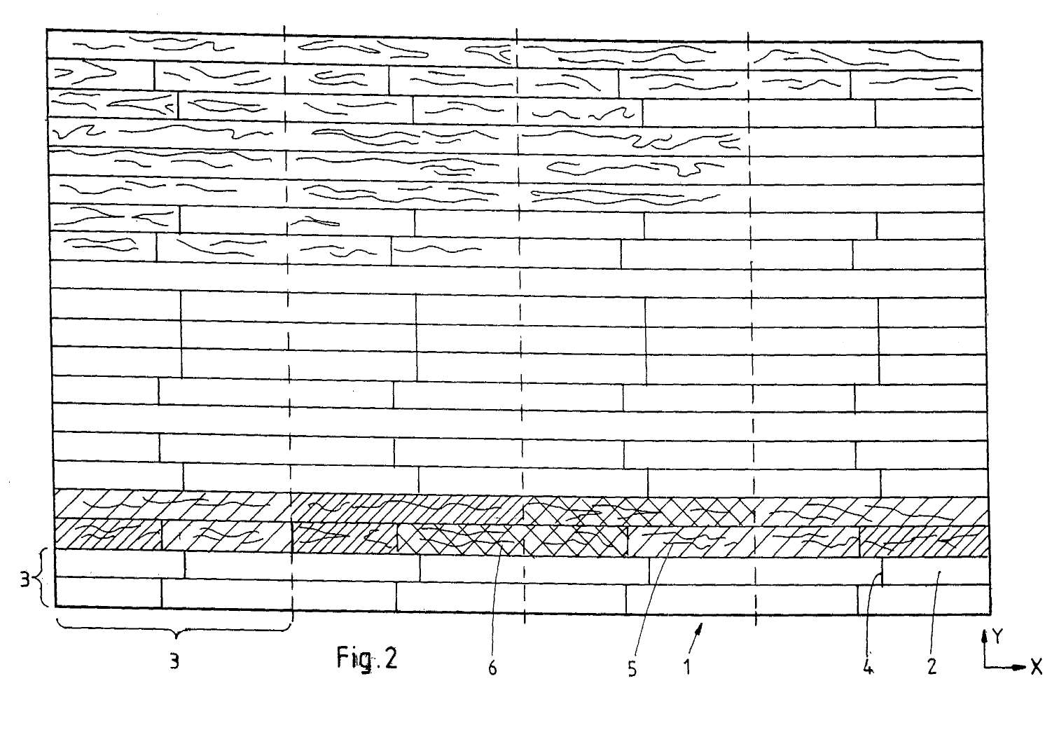

FIG. 2 shows an embodiment of a large surface panel 1 which is manufactured according to a method of the invention. This embodiment also shows that it has a repetitive decoration layer pattern 4 in X direction, but the surface structure pattern 5 does not have a repetitive character after each individual panel 3 in X direction. In this case the frequency of the surface structure pattern 5 is four times lower than that of the decoration layer pattern 4. This means that the decoration layer pattern 4 repeats after each individual panel 3, whereas the surface structure pattern 5 repeats after four individual panels 3 in X direction. This results in 40 different individual panels 3 which can be cut out from the single large surface panel 1. Note, that in FIG. 2 only a part of the surface structure pattern 5 is shown. In practice, the entire large surface panel 1 may be provided with a surface structure pattern 5.

Furthermore, the surface structure 5 can also be adapted by the gloss of the upper surface. This is illustrated in FIG. 2 by regions 6 which are hatched in various manners.

In practice, after manufacturing the individual panels 3 are collected and form a set comprising a plurality of individual panels 3. A set includes at least two individual panels 3 having identical decoration layer patterns 4, but different surface structure patterns 5. The set can be wrapped into one or more packages.

The embodiment of a large surface panel 1 such as shown in FIG. 2 is manufactured by the steps of:
providing a large surface panel 1 having at least one side to be decorated, which is in this case the upper surface 2,
applying a decoration layer on the side in a repetitive decoration layer pattern 4 in at least a machining direction (X direction) along the large surface panel 1,
applying a repetitive surface structure pattern 5 on the side in at least the same machining direction (X direction), wherein the decoration layer and the repetitive surface structure are applied such that the frequencies of the repetitive patterns of the surface structure and the decoration layer 4, 5 are different.

Regarding large surface panel 1 as shown in FIG. 2 the surface structure pattern 5 is applied on the protective layer (not shown) after applying the decoration layer on the large surface panel 1. In that case the surface structure is applied by a surface treatment of the protective layer. The treatment comprises a step of embossing the protective layer. The protective layer is normally applied on a panel by pressurizing it thereon at elevated temperature. The embossing operation can be done by a press plate (not shown).

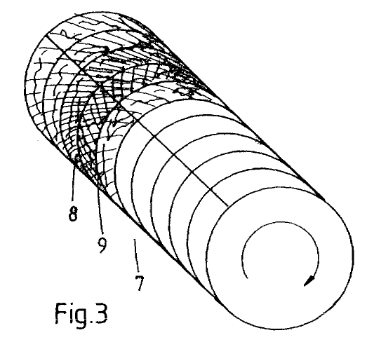

The embossing operation can also be done by using a rotatable embossing roller 7, such as shown in FIG. 3. The roller 7 comprises a circumferential surface 8 which is treated by chemical embossing or mechanical embossing (for example by laser engraving) to obtain embossed regions 9 on the surface 8. The embossed regions 9 can be embossed such that both texture and gloss of the protective layer are adapted. During the manufacturing process the embossing roller 7 presses the protective layer onto the panel under hot circumstances to form the panel 1 as a laminate panel, in this case including embossed regions on the upper surface 2 of the large surface panel 1. It is possible that during the embossing treatment of the protective layer, the decoration layer and/or the core which are below the protective layer, may be embossed, as well.

The roller 7 as shown in FIG. 3 includes four embossed regions 9 in circumferential direction thereof (they are not all visible in FIG. 3). This is to illustrate that during operation of the roller 7, when it rotates and presses the protective layer against the large surface panel 1, four subsequently passing units of the decoration layer pattern 4 will receive a surface structure pattern 5 which varies over those four units. Of course, the ratio between the frequency of both patterns 4, 5 may be varied. In a next rotation step of the roller 7 a next large surface panel 1 will be provided with the same surface structure pattern 5. This means that the surface structure pattern 5 has a repetitive character for large surface panels 1 being manufactured one-by-one (i.e. each large surface panel 1 has similar surface structure patterns 5), but the pattern 5 is not repetitive or less repetitive within each large surface panel 1.

In the case of using a press plate instead of a roller 7, the press plate may provide the large surface panel 1 with a non repetitive surface structure pattern 5, whereas the decoration layer pattern 4 may have a repetitive character, such as shown in FIG. 2.

In order to imitate a natural appearance the surface structure pattern 5 can be derived from a natural material (not shown) by preparing an outer surface of a piece of the natural material by etching, and then scanning an image thereof. The image can be loaded in a control program of a machine for applying the surface structure pattern onto the embossing roller 7, for example. While applying a different surface structure pattern on the same decoration pattern it is still possible to use embossing in register.

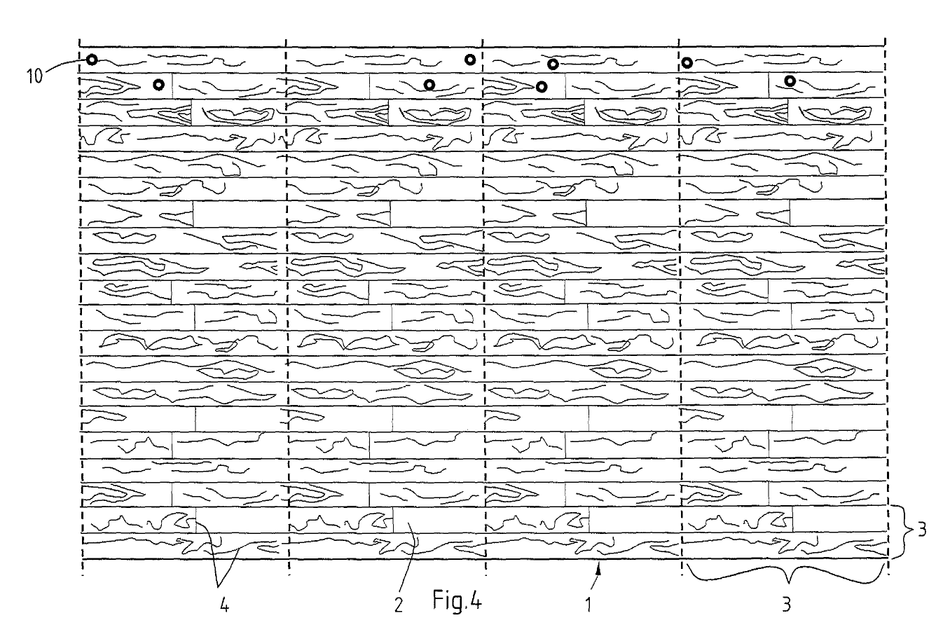

FIG. 4 shows an alternative embodiment of a large surface panel 1 which is manufactured by an alternative method. The panel 1 is provided with a protective layer, which forms a second decoration layer, since it bears a second repetitive decoration layer pattern 10. The second decoration layer is substantially transparent, such that the decoration layer pattern 4 is not hidden by the second decoration layer. Note, that in FIG. 4 only a part of the second decoration layer pattern 10 is illustrated by circles. In practice, the entire large surface panel 1 may be provided with the second decoration layer pattern 10 and the second decoration layer panel may have patterns such as wood grains or knots and the like, so as to further increase the natural appearance of individual panels 3.

In this embodiment the panel 1 has a repetitive decoration layer pattern 4 in X direction. The decoration layer pattern 4 of FIG. 4 comprises straight lines representing borders of wood planks as well as curved lines representing wood grains. It can be seen that the patterns 4 on the individual panels 3 repeat in X direction.

The embodiment of FIG. 4 does not have a surface structure pattern, but this may be applied as well, of course. The second decoration layer pattern 10 in the embodiment does not have a repetitive character after each individual panel 3 in X direction. In this case the frequency of the second decoration layer pattern 10 is four times lower than that of the decoration layer pattern 4. This means that the decoration layer pattern 4 repeats after each individual panel 3, whereas the decoration layer pattern 10 repeats after four individual panels 3 in X direction. This results in 40 different individual panels 3 which can be cut out from the single large surface panel 1. In practice, the protective layer may be an overlay on which there is printed an overlay pattern 10 which is thus superposed on the decoration layer pattern 4 to form a combined pattern of the decoration layer pattern 4 and the second decoration layer pattern 10.

In the case of also varying the surface structure pattern 5 (not shown in FIG. 4), the number of possible variations increases dramatically, since the surface structure pattern 5 may form a second pattern and the second decoration layer pattern 10 may form a third pattern, both patterns superposed on the decoration layer pattern 4. The alternative method of manufacturing the large surface panel of FIG. 4 includes the following steps:
providing a large surface panel 1 having at least one side 2 to be decorated,
applying a decoration layer on the side 2 in a repetitive decoration layer pattern 4 in the machining direction X along the large surface panel 1,
applying a second substantially transparent decoration layer bearing the second repetitive decoration layer pattern 10 in the same machining direction X, such that the frequencies of the repetitive patterns of the decoration layers 4, 10 are different.

The second substantially transparent decoration layer, or in this case the protective layer or overlay, may be applied as one piece on the large surface panel 1. This provides the opportunity to apply protective layers having different patterns 10 printed thereon so as to further increase the number of possible variations, since even large surface panels 1 vary with respect to each other in this case.

From the foregoing it will be clear that aspects of the invention provide a method of manufacturing a large surface panel which presents a very good imitation of a panel of a natural material. It may be clear that due to the variation of the surface structure pattern (both in texture and gloss) and/or the pattern of the second decoration layer an assembly of individual panels in a covering will provide a natural appearance, as well.

The invention is not restricted to the above-described embodiments, which can be varied in a number of ways within the scope of the claims. For instance, the embossing roller could be replaced by an embossing plate, combined with embossing release papers between a plurality of panels to be manufactured, for example. In addition to a floor covering the individual panels may be used for wall or ceiling covering, as well, for example.

1. A method of manufacturing a large surface panel the method comprising:
providing a large surface panel having at least one side to be decorated,
applying a decoration layer on the side in a repetitive decoration layer pattern in at least a machining direction along the large surface panel,
applying a repetitive surface structure pattern on the side in at least the same machining direction, wherein the decoration layer and the repetitive surface structure are applied such that the frequencies of the repetitive patterns of the surface structure and the decoration layer are different.

2. The method according to claim 1, wherein the frequency of the surface structure pattern is lower than that of the decoration layer pattern.

3. The method according to claim 1, wherein the ratio between the frequencies is a whole number.

4. The method according to claim 1, wherein the surface structure pattern is applied after applying the decoration layer.

5. The method according to claim 4, wherein the surface structure pattern is applied by applying a protective layer onto the decoration layer and then applying a surface treatment of the protective layer to adapt the texture and/or the gloss of the surface structure.

6. The method according to claim 5, wherein the surface treatment comprises embossing the protective layer.

7. The method according to claim 6, wherein an embossing roller is applied for embossing the side of the large surface panel.

8. The method according to claim 7, wherein the embossing roller has a circumferential surface which is treated by chemical embossing or mechanical embossing to obtain at least an embossed region on the surface.

9. The method according to claim 1, wherein the surface structure pattern is derived from a natural material by preparing an outer surface of a piece of the material by etching, scanning an image thereof, loading the image in a control programme of a surface structuring machine, and the surface structure pattern is applied by the machine.

10. The method according to claim 1, wherein the large surface panel is cut into individual panels in at least the machining direction.

11. The method according to claim 10, wherein the individual panels are cut out at such lengths that each adjacent individual panel has an identical decoration layer pattern.

12. A large surface panel comprising at least an upper surface provided with a decoration layer having a repetitive decoration layer pattern in at least one direction along the surface, and a repetitive surface structure pattern in at least the same direction, wherein the frequencies of the repetitive patterns of the surface structure and the decoration layer re different.

13. A set of individual panels, wherein each individual panel has at least a side provided with a decoration layer having a decoration layer pattern, and a surface structure pattern, wherein the set at least comprises two individual panels including identical decoration layer patterns, but different surface structure patterns.

14. A set of individual panels according to claim 13, wherein the set is wrapped into at least a package.

15. An apparatus for manufacturing a large surface panel according to the method such as defined in claim 1.

16. A method of manufacturing a large surface panel, the method comprising:
providing a large surface panel having at least one side to be decorated,
applying a decoration layer on the side in a repetitive decoration layer pattern in at least a machining direction along the large surface panel,
applying at least one of a repetitive surface structure pattern on the side and a second substantially transparent decoration layer bearing a second repetitive decoration layer pattern in at least the same machining direction, wherein the decoration layer and at least one of the repetitive surface structure and the second decoration layer are applied such that the frequencies of the repetitive patterns of the surface structure and at least one of the decoration layers, or of the repetitive patterns of the decoration layers, are different.

17. The method according to claim 16, wherein the second decoration layer is a protective layer applied onto the decoration layer, and the repetitive surface structure pattern is obtained by applying a surface treatment of the protective layer to adapt the texture and/or the gloss of the surface structure.

18. A large surface panel comprising at least an upper surface provided with a decoration layer having a repetitive decoration layer pattern in at least one direction along the surface, and at least a second pattern superposed on the decoration layer pattern in at least the same direction, wherein the frequencies of the repetitive patterns, are different.

19. The large surface panel according to claim 18, wherein the decoration layer is covered by a second substantially transparent decoration layer having a second decoration layer pattern which forms the second pattern, which second decoration layer is adapted such that it has a surface structure pattern which forms a third pattern.

20. A method of manufacturing a large surface panel, the method comprising:
providing a large surface panel having at least one side to be decorated,
applying a decoration layer on the side in a repetitive decoration layer pattern in at least a machining direction along the large surface panel,
applying at least a second pattern superposed on the decoration layer pattern in at least the same machining direction,
wherein the frequencies of the repetitive decoration layer pattern and of the second pattern are different.

21. A panel comprising on at least a side a laminate including a decoration layer having a decoration layer pattern, and an overlay on which there is printed an overlay pattern which is superposed on the decoration layer pattern to form a combined pattern.

22. The panel according to claim 21, wherein the overlay has a surface structure pattern which differs from the patterns of the decoration layer and the overlay.

23. A set of individual panels, wherein each individual panel has at least a side provided with a decoration layer having a decoration layer pattern, and at least a second pattern superposed on the decoration layer pattern in at least the same direction, wherein the set at least comprises two individual panels including identical decoration layer patterns, but different second patterns.

24. A set of individual panels, wherein each individual panel has at least a side provided with a decoration layer having a decoration layer pattern, and second and third patterns superposed on the decoration layer pattern in at least the same direction, wherein the set at least comprises two individual panels including identical decoration layer patterns and identical second patterns, but different third patterns.
